(19) United States
(12) Patent Application Publication
(10) Pub. No.: US 2018/0066547 A1
(43) Pub. Date: Mar. 8, 2018

(54) SYSTEM AND METHOD FOR GENERATION OF ELECTRICITY FROM ANY HEAT SOURCES

(71) Applicant: Mikhail M. Vaynberg, San Francisco, CA (US)

(72) Inventor: Mikhail M. Vaynberg, San Francisco, CA (US)

(21) Appl. No.: 15/257,008

(22) Filed: Sep. 6, 2016

(51) Int. Cl. F01K 13/02; F01K 25/08; F01K 11/00; F01K 15/00; F01K 13/00; H02K 7/18

(52) U.S. Cl. CPC F01K 13/02; F01K 25/08; H02K 7/1823; F01K 15/00; F01K 13/003; F01K 11/00

(57) ABSTRACT

Transforming any heat sources to electric power, comprising a closed-cycle charged refrigerant loop. Low-pressure refrigerant fluid is pumped at 10 to 15 degrees F. higher of the ambient temperature through a heat exchanger heated by the heat of the gas outlet from the expander then to the boiler (heat exchanger) to boil the refrigerant liquid into a high-pressure and high temperature superheated by a few deg. F. gas (depending on the kind of refrigerant). Heated/pressurized refrigerant gas is inlet into an expander to power an output shaft during the expansion of the pressurized to a cooled gas. Cooled gaseous refrigerant with still high temperature is inlet to small heat exchanger to heat up the pumped liquid refrigerant before inlet to the boiler. The lowered temperature gas is condensed in condenser to liquid at low pressure and 10 to 15 degrees F. higher of ambient temperature media, and recycled by a pump to the heat exchangers. The refrigerant gas mass flow pressure drop spins the expander shaft for direct mechanical power take-off, or coupling to a synchronous or inductive generator to produce electricity. The electricity can be used locally, stored or fed to the grid.

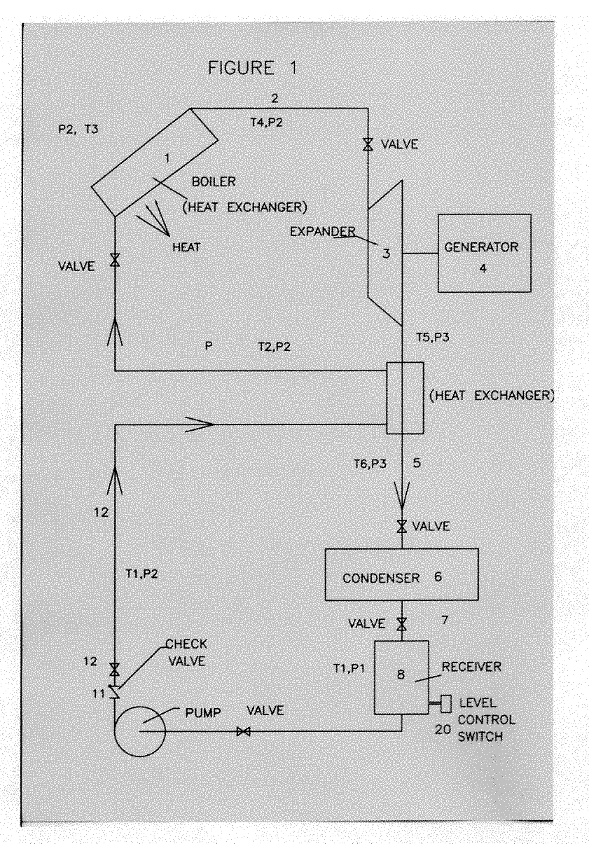

### BACKGROUND

Currently, enormous amounts of Mega Vats are generated daily by a wide variety of power plants and everything is connected to the electrical grid. In case of cyber-attack, there will be no electricity anywhere. Internet will not function and transportation, utilities, communication will be out of service. Installing the proposed invention will make everything autonomous. The homes, buildings, businesses, cars will have their own power. No additional power plants are needed, no transmissions, and no additional work to install all these. The cars will be electrical and the exhaust temperature will be close to ambient temperature. Therefore, electricity or power can be generated from any natural or man-made heat.

### FIELD OF THE INVENTION

The invention relates to the field of power generation, both direct mechanical and electrical, from any heat source, and more particularly to the generation of electricity at any home, building, power plant without the engines (like a home water or air heater), smoke-stacks, cooling towers and at least about one third of fuel used. The inventive power generation system and method is realized in the preferred embodiment as a modular, skid-mounted system, but may also be adapted for permanent installation for stationary power generation in association with an industrial or commercial installation and any cars. The inventive system employs, as a non-limiting example, savings of fuel by means of circulation of a working fluid (refrigerant) in a closed loop system wherein drop in pressure is through an expander unit having a power take-off to power an electrical generator, either synchronous of inductive, or an electrical motor to run in reverse a direct mechanical power take-off. The preferred expander should be selected to accommodate the selected refrigerant. Small expanders should be redesigned from small compressors and manufactured. The refrigerant loop includes a condenser cooled by a heat sink, preferably a water or air-cooled condenser. By appropriate selection of the generator, both DC and AC (single or multiphase) generators as well as any electrical motors running in reverse can be obtained. The system permits cost effective recovery of power from at any installation, and, importantly, the operating power requirement of the inventive system is a minor percentage of power produced, typically less than 10% of the power produced.

### SUMMARY, INCLUDING OBJECTS AND ADVANTAGES

The invention comprises systems and methods, including computer programs containing operating algorithms (such as PLC-enabled control algorithms).

In its broadest implementation, the system of the invention comprises a closed cycle loop of refrigerant pumped initially as a fluid under pressure and at near ambient temperature through heat exchangers to which the heat is provided. The refrigerant fluid extracts heat energy from the heat source in the heat exchangers, in the process being converted to a high-pressure gas. The heated, pressurized refrigerant gas is inlet into an expander to power an output shaft during the expansion of the gas to a cooled gas. The cooled gaseous refrigerant is further cooled in a heat exchanger and then in condenser, which converts it to a liquid at low pressure and close to ambient temperature. The liquid refrigerant then is pumped under pressure back through the heat exchangers to repeat the cycle.

The expander. The drop in pressure and temperature of the refrigerant gas spins the expander shaft, which thereby can be employed as a direct mechanical power take off, or coupled to a synchronous or inductive generator or an electrical motor in reverse to produce electricity.

The condenser functions as a heat exchanger, extracting heat from the refrigerant gas, during which it condenses to a liquid at near ambient temperature. The condenser is cooled by air, or water, or other appropriate heat sink that is sized to provide the DELTA.T necessary for the full condensation of the mass flow of the gases. The condenser liquid refrigerant outlet is connected to a receiver that functions a holding tank or sump to provide a gravity head for the refrigerant loop pump (the Working Fluid Pump, or WFP).

The refrigerant WFP pump is located on the low pressures side of the system loop, preferably between the receiver and the check valve before the inlet side of the heat exchangers. The pump, in that location, raises the pressure of the liquid refrigerant to the design parameter for inlet into the boiler (heat exchanger).

The control system of the inventive power generation system includes appropriate liquid temperature in the boiler and superheat temperature of the boiler outlet gas TD. The difference between the liquid temperature and superheated gas controls the refrigerant flow by changing the speed of the pump output and condition sensors as well as PLC controller(s) for the pump(s) and one or more control algorithms for system start-up, steady state operation, shut down, and upset control.

The system power output is controlled by the flow rate of the Working Fluid Pump (WFP). The speed of the WFP is controlled by a Variable Frequency Drive (VFD), with an analog voltage signal generated by the PLC. The WFP is driven so that a selected Temperature Difference TD, DELTA. There are three loops in the control system. Control System Loop 1, the TD loop provides a fine adjustment to the WFP flow rate. The several temperature and pressure signals are processed by the CPU of the PLC and may be conditioned by digital representations of thermodynamic equations, lookup tables, or graphs. For dynamic signal conditioning, an optional PID algorithm may be applied. Integrator action is applied to keep the voltage signal to the VFD at the desired level. Standard limit blocks to cover upset conditions, including emergency shut-down, may be used as needed, for example, where source or heat exchanger temperature is too low, the DELTA.T requirements are not met, the working fluid remains partly in the gaseous state after the condenser, the cooling tower is not running or is inefficient (such as due to conditions of ambient temperature, pressure or humidity in the area where the inventive unit is installed).

Any type or size of synchronous or inductive generator appropriate for the input shaft speed of the expander can be employed. For example, DC power can be produced with a DC generator. AC power of singe or 3-phase can be produced with an appropriated AC generator. The generator unit includes a conventional speed control and an automatic gateway controller to match the load requirements of the receiving power grid, whether that grid is local, regional or wide area, that is, the grid to which the produced power is provided or sold. The power produced by the inventive system in prototype testing has proven to be extremely clean and free of spikes.

By way of example, and not by way of limitation, current design parameters indicate that the inventive system, sourcing off any heat source providing 220 degrees. F. gases, steam or water to the heat exchanger will permit the system to produce, via a synchronous generator, 15 KW of power of 120-240 V AC, single or 3-phase at 50-60 Hz at an 8% system power draw at a refrigerant fluid flow of 4.2 gpm at 85 degrees F. at DELTA.P of 125 psig inlet to the heat exchanger. The 3-phase power can also be generated at elevated voltages of 2300V, 4160 V or 13.5 KV with larger expander and generator units in the system loop. Although it is preferred that during steady state operation the inventive system uses a portion of its produced power for system operation (e.g., controller and pumps operation).

The inventive system can be sized to the heat source, and is conveniently skid-mountable so that the system can be provided as a factory-made, modular, shippable unit for simple installation and hook up at a customer site. In such a modular unit form, a unit of the inventive system includes: a PLC or other type of controller, sensors, piping, valves, pumps, expander, generator, oil separator (if required for an oil loop lubricated expander), condenser, bypass and receiver, flanges for connection of the refrigerant pressurized inlet to the heat exchangers and outlet to the expander and flanges for connection to a heat sink for the condenser. The condenser heat sink is preferably an air-cooling fan or water-cooling tower that is provided as part of the inventive system on a separate skid, or may be a local, pre-existing cooling tower or other heat sink. Likewise, a boiler (heat exchanger) can be supplied on a separate skid with flanges for connection of the heat fluid source inlets and outlets to the heat exchanger, and the inlet from the system refrigerant pump and the outlet to the expander. Thus, typically the inventive system is provided in pre-manufactured modules of from 1-3 skid-mounted units having mating connections for simple site installation and operational set-up.

In an alternative embodiment, the system of the invention can employ a plurality of heat exchangers in the refrigerant loop. In this embodiment, there are a number of realizations in practice that can be employed. For example, two heat exchangers from different heat sources can be arranged, one upstream of another, so that the first acts as a pre-heater of the refrigerant before it goes through the second which raises the refrigerant temperature to flash it to gas at the selected pressure before entering the inlet side of the expanded. In this arrangement, the pre-heater could be from an even lower grade heat source, or the pre-heater could be connected to the outlet from the pump to upstream heat exchanger. In the latter case, the heat exchangers are arranged in series, counter-flow to the direction of flow of refrigerant in the system loop.

Accordingly, the inventive power generation system permits the efficient extraction of any heat source the production of electrical and direct shaft power to the electrical grid system to site-used electrical or mechanical power for operation of systems or machines. It should be understood that any the mass flow of the refrigerant fluid would be selected to match the work output of the expander to the requirements of a selected induction or asynchronous, generator having a particular winding factor. For an inductive generator, typically operating in the 1750-1850 rpm range, the grid establishes the field winding, so that the output electrical power can be “pushed” onto the grid (supplied to the grid).

An induction machine, connected to a polyphase exciting source on its stator side, can be made to generate (i.e., the power flow would be reversed compared to that of a motor) if its rotor is driven mechanically by external means at above synchronous speed and the motor slip becomes negative. That is, and induction motor, if driven above its synchronous speed when connected to an AC power source (external grid or circuit) will deliver power back to the external circuit. The polyphase exciting source will be what produces the field at which the induction motor will generate its power. That is, the induction generator must be operated in parallel with an electric power system, or independently with a load supplemented by capacitors.

The parallel circumstance is created in the induction motor by an overhauling load; it may also be imposed by driving the rotor at greater-than-synchronous speed by the prime mover. In ranges up to about 500 hp, the induction motor may be used as an induction generator, but not as a primary power source. Generation is impossible without an available polyphase source; the source must provide the exciting current component (and thereby the synchronous flux), even though the superimposed induced currents delivery of power to the supply system.

An induction generator delivers an instantaneous 3-phase, R, S, T, short-circuit current equal to the terminal voltage divided by its locked-rotor impedance. Its rate of decay is much faster than that of a synchronous generator of the same rating, corresponding to the sub-transient time constant; sustained short-circuit current is zero. The virtue of an induction generator is its ability to self-synchronize when the stator circuit is closed to a poser system. Induction generators also have been used for high-speed, high-frequency generators because of their squirrel-cage rotor construction.

The cold liquid refrigerant is pumped through the auxiliary heat exchanger and warms up from T1 to T2 temperature and then enters the boiler.

The refrigerant boils out at P2 and T3 the gas is superheated a few degrees (T4) and then enters the expander.

The refrigerant gas after the expender is still hot (T5, P3) and warms up the cold liquid refrigerant in the auxiliary heat exchanger (T6, P3) and then condensed in air or water-cooled condenser at (T1, P1).

The condensed liquid refrigerant temperature is about five to 15 degrees over the cooling media depending on the design. The condensed refrigerant enters the receiver and then is pumped back to the boiler.

The temperatures, pressures, superheat delta T, depend on the kind of refrigerant, heat exchangers design and ambient temperatures.

The auxiliary heat exchanger for small systems can be omitted for cost considerations.

1. System for generation of electricity from any heat sources, comprising in operative combination:
a) a closed loop, refrigerant working fluid circuit comprising:
i. at least two heat exchangers providing heat energy from any heat source to convert said working fluid from a liquid at low pressure and temperature refrigerant to a superheated gas refrigerant under high pressure;
ii. an expander driven by said heated, pressurized refrigerant working fluid to produce power to an output shaft, said working fluid pressure being thereby reduced, and said expander to run in circuit so that said refrigerant working fluid drives said output expander shaft while dropping in pressure and temperature.
iii. A generator driven by said expander output shaft to produce electricity, said generator is selected from any type generator and an electrical motor running in reverse;
iv. a condenser for condensing said pressure and temperature refrigerant working fluid gas after the second heat exchanger thereby converting the working fluid gas to a liquid at the condensation temperature of 10 to 15 degrees F. above ambient temperature.
v. A pump for delivering and circulating said refrigerant working fluid in said circuit, said pump is driven by a variable frequency drive controlled by TD temperature difference of the liquid refrigerant in boiler and gas temperature inlet the expander.
vi. Conduits interconnecting said heat exchangers, said expander, said condenser and said pump in a closed loop refrigerant circuit, said working fluid is selected from R123, 245fa, and the like organic refrigerants, and said circuit includes a monitoring and controlling said gas temperature of the refrigerant working fluid.
b) A controller for monitoring said generator and selected temperatures and pressures of the refrigerant working fluid in pressurized liquid and gas form in said circuit, and for providing control signals to control said pump, and generator variable frequency drive.

2. System as in claim 1 wherein said expander should be comparable to selected refrigerant and can be at least one.

3. System as in claim 1 wherein two said heat exchangers can be single or multi-stage and can be at least two. For small home generators the small heat exchanger can be omitted.

4. System as in claim 1 wherein said circuit includes a receiver downstream of said condenser to provide a reservoir for said cooled fluid refrigerant for said working fluid pump and can be at least one.

5. System as in claim 4 wherein said condenser is cooled by air or water and can be at least one. Water-cooled condenser comprising at least one of a cooling tower and a cooling water sump system.

6. System in claim 1 wherein said generator can be a simple electrical motor in reverse using direct power and can be at least one.

7. System as in claim 1 wherein said controller includes a PLC having at least one control loop, temperature and pressure inputs representing measurements of actual expander input pressure and temperature and expander outlet temperature, generator rpm and frequency control and power monitoring condenser control, output to said variable frequency drive, a program including pre-selected expander input temperature, pressure and DELTA.T, and outputs for control of pump frequency control and on/off, and generator on/off-line control.

8. Method of generation of direct shaft power or electricity from heat of any sources, comprising the steps in operative sequence of:
a) providing any heat source to pressurize liquid refrigerant working fluid to heat said working fluid to a higher temperature and pressure gas, said working fluid is selected from R123, 245FA, and the like organic refrigerants;
b) pumping said refrigerant in a closed refrigerant working fluid loop circuit said pump being driven with a variable frequency drive controlled by TD temperature difference of the fluid and gas inlet expander;
c) driving an expander having an output shaft with said heated, pressurized gas thereby reducing the pressure of said gas, said expander comprising an expander so that said refrigerant working fluid drives said output shaft while dropping in temperature and pressure;
d) Driving at least one of a synchronous or induction generator to produce electricity or a power take off with said output shaft;
e) condensing said refrigerant working fluid gas to a liquid at its condensation temperature;

9. Recycling said refrigerant working fluid liquid under pressure to said any heat source in a closed working fluid circuit; and

10. Monitoring and controlling the flow, pressures and temperatures of said working fluid liquid and gas in said circuit to generate electricity or direct power from said expander output shaft, said monitoring and control steps include monitoring said shaft and selected temperatures and pressures of the working fluid in liquid or pas form in said circuit and for providing control signals to control said pump and generator variable frequency drive.
a) Method as in claim 10 wherein said monitoring and control steps include providing a PLC having at least one control loop, temperature and pressure inputs representing measurements of actual expander input pressure and temperature and expander outlet temperature, generator or expander output shaft rpm and power monitoring, control of cooling of said expander output gas to a liquid, output to said variable frequency drive, a program including pre-selected expander input temperature, pressure and DELTA.T, and outputs for control of pump on/off, control of valves and control of generator on/off-line status.
b) Method of generation of direct shaft power or electricity from any heat sources, comprising the steps in operative sequence of:
i. providing heat source to a liquid working fluid to heat said working fluid to a higher temperature, pressurized gas;
ii. driving an expander having an input with said heated, pressurized gas thereby reducing the pressure and temperature of said gas, working fluid gas drives said expander output shaft;

11. Condensing said working fluid gas to a liquid at 10 to 15 degrees above cooling media temperature;

12. Recycling said working fluid liquid to said heat source in a closed working fluid circuit, said recycling comprises pumping with a controllable variable frequency drive said liquid working fluid under pressure through heat exchangers to absorb heat from said heat source; and

13. Monitoring and controlling the temperatures of said working fluid liquid and gas in said circuit to generate electricity or direct power from said expander output shaft, said monitoring and controlling include monitoring said expander output shaft and selected temperatures and pressures of the working fluid in liquid or gas form in said circuit and providing control signals to control said pump, expander and generator, including providing a PLC having at least one control loop, temperature and pressure inputs representing measurements of actual expander input pressure and temperature and expander outlet temperature, generator or expander output shaft rpm and power monitoring, control of cooling of said expander output gas to a liquid, monitoring and controlling the said pump providing proper amount of working fluid to the heat exchangers output to said variable frequency drives, a program including pre-selected expander input temperature, pressure and DELTA.T, and outputs for control of pump and generator variable speed and on/off, control of heat supply and on/off-line status.

14. System as in claim 1 wherein said expander, generator, condenser, pump and refrigerant fluid circuit conduit components are mounted on a portable skid on home power generators, or stationary on power plants, or in any cars.

15. System as in claim 14 wherein said any heat supplied to said boiler (heat exchanger) is heat of gas, or any other fuel or heat source.

16. System as in claim 1 wherein the refrigerant pressure input into said expander is consistent to pressure of selected refrigerant as well as the refrigerant gas pressure out of said expander.
